(19) United States
(12) Patent Application Publication
(10) Pub. No.: US 2025/0253668 A1
(43) Pub. Date: Aug. 7, 2025

(54) ELECTRICAL GRID-CONNECTED THREE-PHASE TO THREE-PHASE DIRECT MATRIX CONVERTER

(71) Applicant: BorgWarner Inc., Auburn Hills, MI (US)

(72) Inventor: Brian C. Wightman, Davisburg, MI (US)

(21) Appl. No.: 18/435,186

(22) Filed: Feb. 7, 2024

(51) Int. Cl. H02J 3/32; B60L 53/20

(52) U.S. Cl. CPC H02J 3/322; B60L 53/20; B60L 2210/30

(57) ABSTRACT

A direct current (DC) fast charger for charging batteries of electric vehicles (EVs) includes a primary circuit having nine switching groups, each switching group having a plurality of switches electrically connected in series, that are electrically linked to primary wires of a transformer and configured to directly couple to an electrical grid to receive three-phase alternating current (AC) power and increase the frequency of the AC power; and a secondary circuit, including six switches or diodes arranged to rectify AC power into DC power, that is electrically linked to a secondary wire of the transformer.

### GOVERNMENT INTEREST

This invention was made with government support under the DE-EE0009869 contract, awarded by the United States Department of Energy, Energy Efficiency & Renewable Energy EE-1 Office. The U.S. Government has certain rights in the invention.

### TECHNICAL FIELD

The present application relates to electric vehicles (EVs) and, more particularly, to chargers for charging EVs.

### BACKGROUND

Modern vehicles are increasingly propelled at least partially or wholly by electric motors. The vehicles, often referred to as electric vehicles (EVs), include a vehicle battery and one or more electric motors that drive the vehicle wheels. The vehicle batteries are periodically coupled to a battery charger. Increasing numbers of battery chargers are being installed in various places and it can be helpful to increase the ease with which the battery chargers can be electrically coupled with an electric grid.

### SUMMARY

In one implementation, a direct current (DC) fast charger for charging batteries of electric vehicles (EVs) includes a primary circuit having nine switching groups, each switching group having a plurality of switches electrically connected in series, that are electrically linked to primary wires of a transformer and configured to directly couple to an electrical grid to receive three-phase alternating current (AC) power and increase the frequency of the AC power; and a secondary circuit, including six switches or diodes arranged to rectify AC power into DC power, that is electrically linked to a secondary wire of the transformer.

In another implementation, a DC fast charger for charging batteries of electric vehicles (EVs) includes a primary circuit having a plurality of switching groups, each switching group having a plurality of switches electrically connected in series, that are electrically linked to primary wires of a transformer and configured to directly couple to an electrical grid to receive three-phase alternating current (AC) power and increase the frequency of the AC power; and a secondary circuit, including a plurality of switches or diodes arranged to rectify AC power into DC power, that is electrically linked to a secondary wire of the transformer.

### BRIEF DESCRIPTION OF THE DRAWINGS

FIG. 1 is a block diagram depicting an implementation of an electric vehicle;

FIG. 2 is a circuit diagram depicting an implementation of a DC fast charger AC/DC power converter;

FIG. 3 is a circuit diagram depicting another implementation of a DC fast charger AC/DC power converter;

FIG. 4 is a circuit diagram depicting yet another implementation of a DC fast charger AC/DC power converter; and

FIG. 5 is a portion of a circuit diagram depicting yet another implementation of a DC fast charger AC/DC power converter.

### DETAILED DESCRIPTION

A three-phase to three-phase direct matrix converter can be used in an electric vehicle (EV) battery charger that supplies direct current (DC) electrical power to the EV. Previous direct matrix converters may have been somewhat sensitive to received input voltage and only able to receive a limited range of voltage values. For example, past direct matrix converters may be limited to input voltages that were under 500 volts (V). However, electrical grids may offer electricity existing at much higher voltages, such as 10-33 kilovolts (kV), outside of the limited range of voltage values. The electrical grid could be indirectly connected to past direct matrix converters via a stand-alone transformer that reduced the level of voltage supplied by the electrical grid to an amount acceptable by the direct matrix converter. However, as EV battery chargers are deployed in larger quantities and in a variety of locations, it would be helpful to directly couple the EV battery charger to the electrical grid such that the direct matrix converter can internally convert much higher voltages than past EV battery chargers, without using a separate transformer.

The three-phase to three-phase direct matrix converter can include a primary circuit comprising switching groups that each include a plurality of series-connected switches. The series-connected switches can be directly connected to the electrical grid, receiving an elevated level of voltage and converting the voltage received from the grid internally within the EV battery charger into a lower level of voltage. The quantity of series-connected switches can vary and depend on the performance characteristics of the switches and the voltage level received from the electrical grid. The gates of the series-connected switching groups can be commonly connected to the output of a microprocessor so that the plurality of switches may be opened and closed in unison. The series-connected switches can work bi-directionally to receive electrical power from the grid and provide it to an EV as well as to supply electrical power from the EV to the electrical grid. Other implementations are possible in which the series-connected switches are unidirectional, supplying electrical power from the EV battery charger to the EV, using a secondary circuit comprising passive electrical components.

The present EV battery charger, also referred to as a DC fast charger, can include the three-phase to three-phase direct matrix converter. The direct matrix converter transforms low frequency three-phase AC power to high-frequency three-phase AC power at a primary circuit using a plurality of series-connected switches that can be bidirectional and directly connected to the electrical grid. The high-frequency three-phase AC power can then be converted to DC electrical power at the secondary circuit using six switches or diodes. The secondary circuit providing DC electrical power to the EV can be isolated from the primary circuit receiving AC electrical power form the electrical grid via a transformer. The series-connected switches in the primary circuit and secondary circuit can be configured in a variety of ways, depending on the application. For example, the switches in the primary circuit and the secondary circuit can arranged as a Wye-Wye transformer in one implementation. Or in another implementation, the switches can be arranged as a Delta-Delta transformer. Yet another implementation is a Wye-Delta transformer.

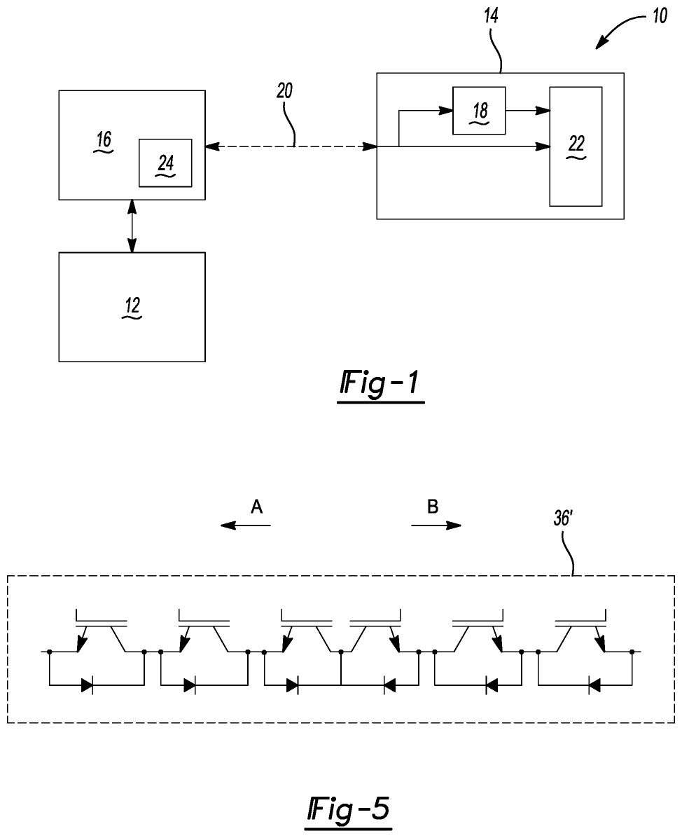

Turning to FIG. 1, an implementation of an electrical system 10 is shown including an electrical grid 12 and an electric vehicle (EV) 14 that can either receive electrical power from or provide electrical power to the grid 12. The electrical grid 12 can include any one of a number of electrical power generators and electrical delivery mechanisms. Electrical generators (not shown) create AC electrical power that can then be transmitted a significant distance away from the electrical generator for residential and commercial use. The electrical generator can couple with the electrical grid 12 that transmits the AC electrical power from the electrical generator to an end user, such as a residence or business. As the AC electrical power is provided to the electrical grid 12, the electrical power can exist at a relatively high voltage so that it can be communicated relatively long distances. Once the electrical power reaches a location where it is intended to be used, electrical transformers (not shown) can be used to reduce the voltage level before ultimately being provided to a residence or business. In one implementation, the voltage level of AC electrical power received is greater than 10 kV AC and less than 33 kV AC three-phase at a frequency of 50-60 hz. However, this voltage can be a different value.

An EV charging station, referred to here as a DC fast charger 16, can receive AC electrical voltage from the grid 12, convert the AC electrical voltage into a higher-frequency AC electrical voltage, convert the higher-frequency AC electrical voltage into DC voltage, and provide the DC electrical voltage to the EV 14. Also, the DC fast charger 16 can receive stored electrical power in the form of DC electrical voltage from an EV battery 22, convert the received DC electrical voltage to AC electrical voltage and transfer it to the grid 12. The DC fast charger 16 can be geographically fixed, such as a charging station located in a vehicle garage or in a vehicle parking lot. The DC fast charger 16 can include an input terminal that receives the AC electrical power from the grid 12 and communicates converted DC electrical power to the EV battery 22 directly, bypassing an on-board vehicle battery charger 18 included on the EV 14. An electrical cable 20 can detachably connect with an electrical receptacle on the EV 14 and electrically link the DC fast charger 16 with the EV 14 so that DC electrical voltage can be communicated between the DC fast charger 16 and the EV battery 22. The DC fast charger 16 can receive AC power from the grid 12 and have a power rating of 180-1100 kW provided to the EV 14. This type of DC fast charging may be referred to as Level 3 megawatt (MW) EV charging. However, the EV charging station can be using different standards. The term “electric vehicle” or “EV” can refer to vehicles that are propelled, either wholly or partially, by electric motors. EV can refer to electric vehicles, plug-in electric vehicles, hybrid-electric vehicles, and battery-powered vehicles. The EV battery 22 can supply DC electrical power controlled by power electronics to the electric motors that propel the EV. The EV battery 22 or batteries are rechargeable and can include lead-acid batteries, nickel cadmium (NiCd), nickel metal hydride, lithium-ion, and lithium polymer batteries. A typical range of vehicle battery voltages can range from 100 to 1000V of DC electrical power (VDC).

The on-board vehicle battery charger 18 can include a power factor correction (PFC) module having a switching circuit that converts AC electrical power into DC electrical power. In addition, the switching circuit 26 can also act as an inverter that converts high frequency AC electrical power received from the DC electrical power through a secondary circuit 28 and transformer into AC electrical power, which can be transmitted outside of the EV 14. A microprocessor 24 electrically linked to the gate of each switch can control the rectification of incoming AC electrical power as well as the inversion of outgoing DC electrical power. The microprocessor 24 can be implemented using computer processing capabilities, such as a microcontroller or other computer processor solely dedicated to the control of the direct matrix, or the as part of a microprocessor that controls other functionality of the DC Fast Charger 14. A control system, implemented as computer-readable instructions executable by the microprocessor, can be stored in non-volatile memory and called on to control functionality of the DC fast charger 16. This will be discussed in more detail below.

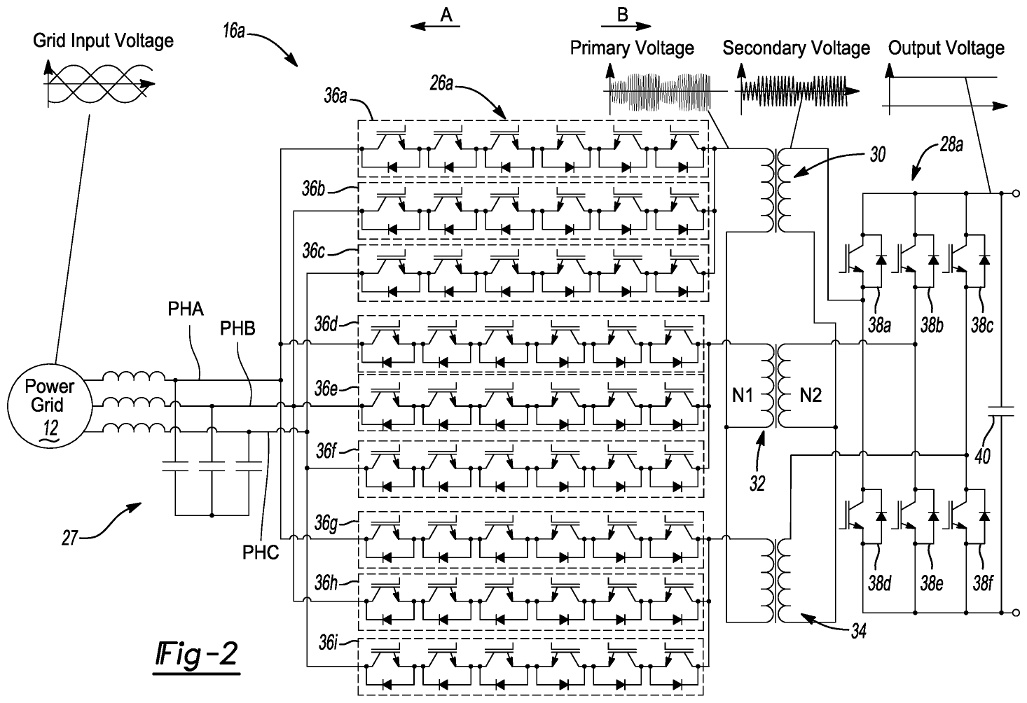

FIG. 2 depicts an implementation of the DC fast charger 16a. The DC fast charger 16a is a direct matrix converter that includes a primary circuit 26a and a secondary circuit 28a inductively coupled together via a plurality of transformers 30, 32, 34. The primary circuit 26a includes nine switch groups 36 electrically coupled to the grid 12. A first phase (PHA) is electrically coupled to three switch groups 36a, 36d, 36g, a second phase (PHB) includes three switch groups 36b, 36e, 36h, and a third phase (PHC) includes three switch groups 36c, 36f, 36i. The switch groups 36 can be implemented using bipolar junction transistors or field effect transistors (FETs), such as insulated gate bipolar transistors (IGBTs), metal-oxide semiconductor field effect transistors (MOSFETs), gallium nitride transistors (GaN), or silicon carbide (SiC) transistors. The switch groups 36 can be bidirectional or reverse-blocking such that they are four-quadrant switches capable of conducting positive or negative on-state current and blocking positive or negative off-state voltage. A number of different circuit configurations can be used to implement such a switch any of which could be implemented in the DC fast charger described herein.

In one implementation, each switch group 36 six MOSFETs electrically connected in series such that the switches have a common emitter. Three of the MOSFETs include diodes biased in a first direction (A) while another three of the MOSFETs include diodes biased in a second, opposite direction (B). The gates of the six MOSFETs can be electrically connected to the microprocessor 24 such that three of the MOSFETs are simultaneously rendered conductive together at the same time. For example, the microprocessor 24 can simultaneously apply a voltage to the gates of the three MOSFETs in a switching group 36 having diodes biased in the first direction (A) while not applying a voltage to the gates of the other three MOSFETs of the switching group 36, thereby rendering the MOSFETs with diodes biased in the second direction (B) non-conductive. The microprocessor 24 can also simultaneously apply a voltage to the gates of the MOSFETs in a switching group 36 having diodes biased in the second direction (B) while not applying a voltage to the gates of the other three MOSFETs of the switching group 36, thereby rendering the MOSFETs with diodes biased in the first direction (A) non-conductive.

The nine switching groups 36a-i can be electrically coupled to three legs of the electrical grid PHA, PHB, PHC. Bulk capacitance 27 can be electrically connected to the legs PHA, PHB, PHC of the grid 12. Each phase and switch groups electrically coupled to each phase can also be coupled to a transformer. The primary circuit 26a and the secondary circuit 28a are shown in a Wye-Wye configuration. For example, the first phase (PHA) can be coupled to switching groups 36a, 36d, and 36f. The second phase (PHB) can be coupled to switching groups 36b, 36e, and 36h. The third phase (PHC) can be coupled to switching groups 36c, 36f, and 36i. Switching groups 36a-c can also be electrically connected to a primary wire of the first transformer 30. Switching groups 36d-f can also be electrically connected to a primary wire of the second transformer 32. Switching groups 36g-i can also be electrically connected to a primary wire of the third transformer 34. The primary wires of the transformers 30, 32, 34 can be electrically connected together such that a common neutral node (N1) exists within the primary circuit 26a. In this implementation, three separate transformers 30, 32, 34 are shown. However, it should be appreciated that a common core transformer could be used instead of three separate transformers such that the primary wires connected to each of the switching groups 36 could be wrapped around a common iron core.

The secondary circuit 28a is electrically connected to secondary windings of the transformers 30, 32, 34. The secondary circuit 28a includes six switches 38a-f. The switches 38 can be implemented using bipolar junction transistor or field effect transistors (FETs), such as insulated gate bipolar transistors (IGBTs) metal-oxide-semiconductor field effect transistors (MOSFETs). The secondary circuit 28a can include a capacitor 40 that smooths the output DC voltage. The EV battery 22 can be electrically connected to the switches 38 such that the secondary circuit 28a rectifies the AC voltage induced through the secondary windings of the transformers 30, 32, 34 into DC voltage applied to the EV battery 22. The secondary circuit 28a can be implemented such that the secondary wires of the transformers 30, 32, 34 are electrically connected to have a common neutral node (N2). In other implementations, the switches 38 in the secondary circuit 28a can be replaced with passive electrical components, such as diodes. The direct matrix converter implemented with the passive electrical components would be uni-directional in the secondary circuit 28a.

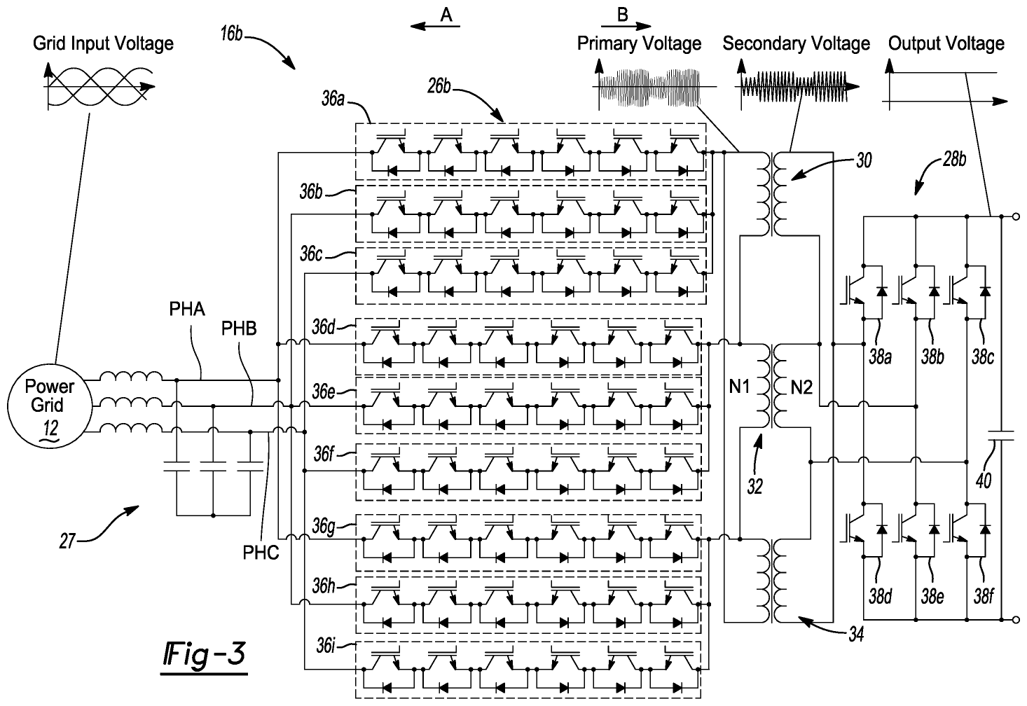

Turning to FIG. 3, another implementation of a DC fast charger 16b is shown. The DC fast charger 16b is a direct matrix converter that includes a primary circuit 26b and a secondary circuit 28b inductively coupled together via a plurality of transformers 30, 32, 34. The primary circuit 26b includes nine switching groups 36 electrically coupled to the grid 12. The primary circuit 26b and the secondary circuit 28b are arranged in a Delta-Delta configuration. The first phase (PHA) can be coupled to switching groups 36a, 36d, and 36f. The second phase (PHB) can be coupled to switching groups 36b, 36e, and 36h. The third phase (PHC) can be coupled to switching groups 36c, 36f, and 36i. Switching groups 36a-c can also be electrically connected to a primary wire of the first transformer 30. Switching groups 36d-f can also be electrically connected to a primary wire of the second transformer 32. Switching groups 36g-i can also be electrically connected to a primary wire of the third transformer 34. The primary wires of the transformers 30, 32, 34 can be electrically connected together in series. The secondary circuit 28b can be implemented such that the secondary wires of the transformers can be wired to the switches 38 in series. In other implementations, the switches 38 in the secondary circuit 28b can be replaced with passive electrical components, such as diodes. The direct matrix converter would be uni-directional with the passive electrical components in the secondary circuit 28b.

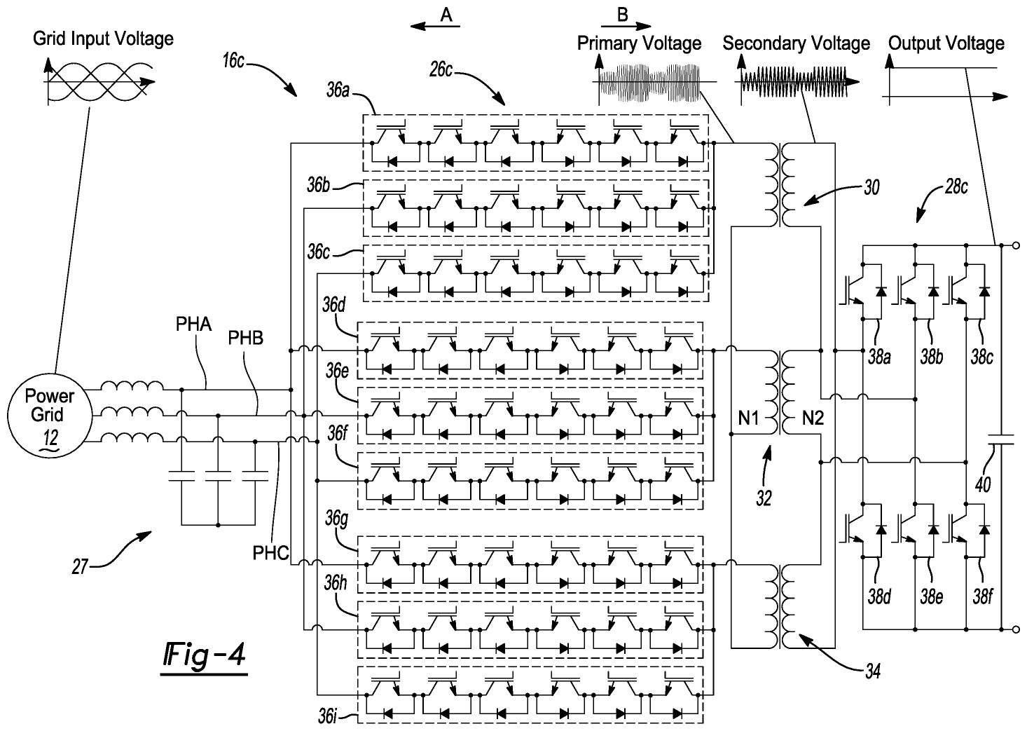

FIG. 4 depicts another implementation of a DC fast charger 16c. The DC fast charger 16c includes a primary circuit 26c and a secondary circuit 28b arranged in a Wye-Delta configuration. The DC fast charger includes the primary circuit 26c and the secondary circuit 26c described above inductively linked via a plurality of transformers 30, 32, 34.

FIG. 5 depicts another implementation of a switching group 36′. The switching group 36 includes six switches electrically connected in series. The switches shown in this configuration may be implemented using MOSFETs, however, other types of switches are possible as noted above. Here, the switches are electrically connected such that they have a common collector.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A direct current (DC) fast charger for charging batteries of electric vehicles (EVs), comprising:
a primary circuit having nine switching groups, each switching group having a plurality of switches electrically connected in series, that are electrically linked to primary wires of a transformer and configured to directly couple to an electrical grid to receive three-phase alternating current (AC) power and increase the frequency of the AC power; and
a secondary circuit, including six switches or diodes arranged to rectify AC power into DC power, that is electrically linked to a secondary wire of the transformer.

2. The DC fast charger recited in claim 1, further comprising a microprocessor, electrically linked to the plurality of switches within each switching group.

3. The DC fast charger recited in claim 1, wherein the DC fast charger includes a plurality of transformers.

4. The DC fast charger recited in claim 1, wherein the DC fast charger includes a single three-phase transformer.

5. The DC fast charger recited in claim 1, wherein the nine switches in the primary circuit are bi-directional.

6. The DC fast charger recited in claim 1, wherein the primary circuit and the secondary circuit are configured in a Wye-Wye orientation.

7. The DC fast charger recited in claim 1, wherein the primary circuit and the secondary circuit are configured in a Delta-Delta configuration.

8. The DC fast charger recited in claim 1, wherein the primary circuit and the secondary circuit are configured in a Delta-Wye configuration.

9. A direct current (DC) fast charger for charging batteries of electric vehicles (EVs), comprising:
a primary circuit having a plurality of switching groups, each switching group having a plurality of switches electrically connected in series, that are electrically linked to primary wires of a transformer and configured to directly couple to an electrical grid to receive three-phase alternating current (AC) power and increase the frequency of the AC power; and
a secondary circuit, including a plurality of switches or diodes arranged to rectify AC power into DC power, that is electrically linked to a secondary wire of the transformer.

10. The DC fast charger recited in claim 9, further comprising a microprocessor, electrically linked to the plurality of switches within each switching group.

11. The DC fast charger recited in claim 9, wherein the nine switches in the primary circuit are bi-directional.

12. The DC fast charger recited in claim 9, wherein the primary circuit and the secondary circuit are configured in a Wye-Wye orientation.

13. The DC fast charger recited in claim 9, wherein the primary circuit and the secondary circuit are configured in a Delta-Delta configuration.

14. The DC fast charger recited in claim 9, wherein the primary circuit and the secondary circuit are configured in a Delta-Wye configuration.
